(19) United States
(12) Patent Application Publication
(10) Pub. No.: US 2016/0304685 A1
(43) Pub. Date: Oct. 20, 2016

(54) USE OF PENTAETHYLENEHEXAMINE IN THE PRODUCTION OF POLYURETHANE SYSTEMS

(71) Applicant: Evonik Degussa GmbH, Essen (DE)

(72) Inventors: Eva EMMRICH-SMOLCZYK, Essen (DE); Olga FIEDEL, Essen (DE); Mladen VIDAKOVIC, Duisburg (DE)

(21) Appl. No.: 15/035,848

(22) PCT Filed: Oct. 23, 2014
(86) PCT No.: PCT/EP2014/072728

§ 371 Date: Jul. 5, 2016

(30) Foreign Application Priority Data
Nov. 18, 2013 (DE) 102013223441.4

(51) Int. Cl. C08J 9/00; C08G 18/48; C08G 18/76; C08G 18/18; C08G 18/08

(52) U.S. Cl. CPC C08J 9/0028; C08G 18/1825; C08G 18/14; C08G 18/7657; C08G 18/4816; C08J 2205/10; C08G 2101/0025

(57) ABSTRACT

The invention relates to a process for production of polyurethane systems by reacting at least one polyol component with at least one isocyanate component in the presence of one or more catalysts for the isocyanate-polyol and/or isocyanate-water reactions and/or the trimerization of isocyanate, wherein said reacting is carried out in the presence of pentaethylenehexamine, and also to correspondingly obtained polyurethane systems.

The invention resides in the field of polyurethane and relates in particular to a process for production of polyurethane systems by reacting at least one polyol component with at least one isocyanate component in the presence of one or more catalysts for the isocyanate-polyol and/or isocyanate-water reactions and/or the trimerization of isocyanate, wherein said reacting is carried out in the presence of pentaethylenehexamine, and also to correspondingly obtained polyurethane systems.

Polyurethane systems for the purposes of this invention are, for example, polyurethane coatings, polyurethane adhesives, polyurethane sealants, polyurethane elastomers or polyurethane foams.

Polyurethane foams have outstanding mechanical and physical properties and so are used in a very wide variety of fields. The automotive and furniture industries are a particularly important market for various PU foams, such as conventional flexible foams based on ether and ester polyols, cold-cure foams (frequently also referred to as HR foams), rigid foams, integral foams and microcellular foams and also foams with properties between these classifications, for example semi-rigid systems. For instance, rigid foams are used as head liner, ester foams as interior door trim and also for die-cut sun visors, cold-cure and flexible foams are used for seat systems and mattresses.

Polyurethane foams evolve aldehydes, especially formaldehyde, in the course of production and storage. Many consumers go out of their way to avoid using formaldehyde-evolving products because of health concerns, however unjustified they may be. This is one reason why foam producers, for example in the furniture industry, in Europe and the USA have adopted the “CertiPUR” program, which is a voluntary program, under which the standard limit for formaldehyde emissions in mattresses is 0.1 mg/m3 when measured using the ASTM Method D5116-97 Small Chamber Test with chamber conditioning for 16 hours. The European chamber test allows 5 μg/1 of formaldehyde and DMF in fresh foams and 3 μg/1 in foams more than 5 days old.

Industry as well as the consumer accordingly wants polyurethane foams that evolve very little, ideally no, formaldehyde.

Different approaches have already been tried to satisfy this want. WO 2009/117479 for instance proceeds on the assumption that the formaldehyde comes from raw material, more particularly suspecting it to be present in the amine catalysts used (which are tertiary amines). Low formaldehyde emissions are proposed to be achieved in this reference by adding a primary amine to the tertiary amine catalyst. Preference is expressed for the use of dimethylaminopropylamine.

DE 10003156 A1 did not relate directly to low-emission foams, but addresses the problem of developing polymers having very good adsorptive capabilities in respect of various compounds, in particular in respect of heavy metal ions. The solution proposed to this problem takes the form of polyurethane foams comprising ethyleneimine, polyethyleneimine, polyvinylamine, carboxymethylated polyethyleneimines, phosphonomethylated polyethyleneimines, quaternized polyethyleneimines and/or dithiocarbamitized polyethyleneimines. These polyurethane foams are also useful for adsorbing organic substances such as, for example, formaldehyde.

DE 10258046 A1 addresses the problem of producing polyurethane foams having a reduced level of formaldehyde emission. In contradistinction to DE 10003156 A1, the problem addressed by DE 10258046 A1 is therefore that of reducing the formaldehyde emissions from the PU foam as such and not that of adsorbing formaldehyde from the ambient air. The solution proposed to this problem is a process that involves the admixture of amino-containing polymers to the polyurethane foam, wherein the admixture may take place before, during or after the production of the polyurethane foam.

It was determined in the context of the present invention that what is problematic with the polyurethane foam is not just its level of formaldehyde emissions, which under customary conditions, i.e. in the presence of light and air, rise in principle with increasing length of storage. It was additionally found that what may also become problematic with a polyurethane foam in the course of its storage, prolonged storage in particular, are the emissions of acetaldehyde—specifically when, as proposed in the prior art, polyethyleneimines are used for formaldehyde reduction.

True, polyurethane foams produced without specific formaldehyde scavengers also evolve some acetaldehyde, but generally at a quite minimal level. In some instances, depending on the formulation, it is even possible to detect an emission of benzaldehyde (as per VDA 278, for example) or acrolein (via diverse chamber test methods, for example).

A person skilled in the art is aware of different analytical methods for determining aldehyde emissions. VDA 275, VDA 277 or else VDA 278 may be cited by way of example, as well as various chamber test methods. VDA is the German Association of the Automotive Industry (www.vda.de/en). “VDA 275” provides a method of measurement for determining the formaldehyde release by the modified bottle procedure. A usable method of measurement is also detailed in the example part of this invention.

It has now been found that, surprisingly, specifically the compounds recited in DE 10003156 A1 and DE 10258046 A1, such as polyethyleneimines for example, do have a positive influence on formaldehyde emission, but regrettably only at the cost of an exceedingly severe increase in acetaldehyde emissions, for example by a factor of 50, compared with systems where the compounds mentioned, for example polyethyleneimines, are not used. Such a severe increase in acetaldehyde emissions is undesirable. This is because there are existing in-principle health concerns and, in addition, acetaldehyde has a quite pungent odor.

Therefore, providers of polyurethanes, in particular polyurethane foams, are still in need of solutions for reducing the emission of formaldehyde without such a severe increase in the emission of acetaldehyde.

The problem addressed by the present invention was therefore that of providing polyurethanes, in particular polyurethane foams, where there is a reduced level of formaldehyde emission and where the level of acetaldehyde emission does not rise in storage to the same severe degree as with the use of polyethyleneimines (PEIs) which is known from the prior art.

The inventors, then, found that, surprisingly, this problem is solved by using pentaethylenehexamine.

The present invention accordingly provides a process for production of polyurethane systems by reacting at least one polyol component with at least one isocyanate component in the presence of one or more catalysts for the isocyanate-polyol and/or isocyanate-water reactions and/or the trimerization of isocyanate, wherein said reacting is carried out in the presence of pentaethylenehexamine.

The problem addressed by the present invention is solved by this subject-matter. It is thus the case that whenever a process for producing polyurethane systems is carried out in the presence of pentaethylenehexamine, it makes possible the provision of polyurethanes, in particular polyurethane foams, having a reduced level of formaldehyde emission but without displaying such a severe increase in the level of acetaldehyde emission as observed on using polyethyleneimines. Advantageously, there is no increase in the level of acetaldehyde emission at all.

The invention reliably minimizes, or advantageously even completely prevents, the emission of formaldehyde even in storage for a prolonged period. In effect, the severe increase observed in the level of acetaldehyde emission in storage on PEI use is advantageously curbed such that the level of acetaldehyde emission, if it is adversely affected at all, is not adversely affected to any significant degree, but at least not to the extent where there is such a severe increase in the acetaldehyde content of the polyurethane foam, for example by a factor of 50, as is the case on using the PEIs. So what is achieved is at the very minimum a distinct reduction in the rise of acetaldehyde emission in the course of storage. More particularly, even after a storage period of 5 months, the increase in the acetaldehyde content of the polyurethane foam is advantageously limited to not more than 2.5 fold as compared with a foam that has not been admixed with any additives to reduce formaldehyde emissions. This is a quite immense improvement over those prior art proposals that involve PEI use.

More particularly, the present invention safely limits the emission of formaldehyde from the already-produced polyurethane system (in particular polyurethane foam) to a value of advantageously not more than 0.02 mg of formaldehyde/kg PU system (PU foam), as may be determined with preference via VDA 275 (as per the modified procedure in the example part), even after a storage period of 5 months.

The process of the present invention accordingly achieves a first in making possible the provision of polyurethane systems (in particular polyurethane foam) that deliver very good results not only with regard to formaldehyde emission but also with regard to acetaldehyde emission. Admixing the pentaethylenehexamine achieves a first in providing polyurethane systems (in particular polyurethane foams) where formaldehyde emissions are reduced, where acetaldehyde emissions are scarcely affected adversely, if at all, and where preferably even comparatively unusual aldehydes such as, for example, propionaldehyde, benzaldehyde or acrolein can be absorbed.

An additional advantage of the invention is that the process of the present invention makes the reactants react in an accelerated manner compared with processes wherein the pentaethylenehexamine is not used.

The compounds used in the present invention, the use of compounds for producing the polyurethane systems/foams and also the polyurethane systems/foams themselves are hereinbelow described by way of example without any intention to limit the invention to these exemplary embodiments. When ranges, general formulae or compound classes are specified hereinafter, these shall include not just the corresponding ranges or groups of compounds that are explicitly mentioned but also all sub-ranges and sub-groups of compounds which can be obtained by removing individual values (ranges) or compounds. Wherever documents are cited within the context of the present description, then their contents, in particular as regards the substantive matter to which reference is made, are deemed as belonging in their entirety to the disclosure content of the present invention. Percentages are by weight, unless otherwise stated. Average values referred to hereinbelow are number averages, unless otherwise stated. When properties of a material are referred to hereinbelow, for example viscosities or the like, the properties of the material at 25° C. are concerned, unless otherwise stated. When chemical (empirical) formulae are used in the present invention, the reported indices can be not only absolute numbers but also average values. Indices relating to polymeric compounds are preferably average values.

Depending on the system into which the pentaethylenehexamine are later incorporated, there may be an advantage in reacting them at least partly with functionalizing reagents in a subsequent step, which is optional in order that such properties as viscosity, solubility, polarity and miscibility may be made as system-adequate as possible. Useful functionalizing reagents include particularly any polymeric or monomeric chemistries with functional groups capable of entering a reaction with amino groups, examples being epoxides, acids, alkyl halides, dialkyl sulphates, etc. This procedure is known per se to a person skilled in the art who, if desired, is routinely able to effect an optional functionalization with the aid of a few hands-on tests. However, it is more preferable to use pentaethylenehexamine as such, without any optional functionalization.

The pentaethylenehexamine may in principle be incorporated in the polyurethane system in any useful amount. However, in a preferred embodiment of the invention the pentaethylenehexamine is used in a mass fraction of 0.0001 to 10 parts, preferably 0.001 to 5 parts, in particular 0.01 to 3 parts based on 100 parts of polyol component.

In addition to the pentaethylenehexamine use required according to the present invention, still further amines may optionally also be added, for example other aliphatic polyamines, and this preferably with a molar mass below 500, advantageously below 300 and especially below 250 g/mol, advantageously comprising at least two or more amino groups, e.g. diethylenetriamine, triethylenetetramine, tetraethylenepentamine, hexaethyleneheptamine, hexamethylenediamine, 1,8-diaminotriethylene glycol, tris(2-aminoethyl)amine. It may similarly also optionally be possible to use still further amines in addition, for example polyamines with a molar mass above 500 g/mol or above 1000 g/mol.

The optional, additional polyamine may be used for example in a mass fraction of 0.0001 to 10 parts, preferably 0.001 to 5 parts, in particular 0.01 to 3 parts, based on 100 parts of polyol component, and this in addition to the pentaethylenehexamine.

It has transpired that the use of pentaethylenehexamine may advantageously even rectify the disadvantages of the compounds recited in DE 10003156 A1 and DE 10258046 A1. Pentaethylenehexamine has proved to be such an excellent aldehyde scavenger that it can even rectify the acetaldehyde emission increase induced by the compounds recited in DE 10003156 A1 and DE 10258046 A1. It is thus the case when the use of compounds as in DE 10003156 A1 and DE 10258046 A1 is nonetheless to be continued for other reasons, its unpleasant side-effects, viz. the runaway increase in acetaldehyde emissions, can be controlled by the admixture of pentaethylenehexamine.

The production of polyurethane systems may otherwise be obtained in the customary manner and as described in the prior art. It is well known to a person skilled in the art. A comprehensive overview is found in, for example, G. Oertel, Polyurethane Handbook, 2nd edition, Hanser/Gardner Publications Inc., Cincinnati, Ohio, 1994, p. 177-247. All that matters is that the reaction is carried out in the presence of pentaethylenehexamine.

It may be advantageous to conduct the process of producing the polyurethane systems in the manner of the present invention to additionally admix water, physical blowing agents, flame retardants and/or further additives.

It is particularly preferable for the polyurethane system produced to be a polyurethane foam.

Any isocyanate may be used as isocyanate component in the process of the present invention, especially the aliphatic, cycloaliphatic, araliphatic and preferably aromatic polyfunctional isocyanates known per se. Suitable isocyanates for the purposes of this invention include preferably any polyfunctional organic isocyanates, for example 4,4″-diphenylmethane diisocyanate (MDI), toluenediisocyanate (TDI), hexamethylene diisocyanate (HMDI) and isophorone diisocyanate (IPDI). The mixture of MDI and more highly condensed analogues having an average functionality of 2 to 4 which is known as crude MDI (“polymeric MDI”) is particularly suitable, as well as each of the various isomers of TDI in pure form or as isomeric mixture. Mixtures of TDI and MDI are particularly preferred isocyanates.

All organic substances having two or more isocyanate-reactive groups, and also preparations thereof, are preferably suitable polyols for the purposes of this invention. All polyether polyols and polyester polyols typically used for production of polyurethane systems, especially polyurethane foams, are preferred polyols. The polyols are preferably not compounds having one or more than one 5- or 6-membered ring constructed of one or two oxygen atoms and carbon atoms.

Polyether polyols are obtainable for example by reacting polyfunctional alcohols or amines with alkylene oxides. Polyester polyols are preferably based on esters of polybasic carboxylic acids (which may be either aliphatic, as in the case of adipic acid for example, or aromatic, as in the case of phthalic acid or terephthalic acid, for example) with polyhydric alcohols (usually glycols). Natural oil based polyols (NOPs) can also be used. These polyols are obtained from natural oils such as soya or palm oil for example and can be used in the modified or unmodified state.

A further class of polyols are those which are obtained as prepolymers via reaction of polyol with isocyanate in a molar ratio of 100:1 to 5:1, preferably 50:1 to 10:1. Such prepolymers are preferably used in the form of a solution in the polyol, and the polyol preferably corresponds to the polyol used for preparing the prepolymers.

A still further class of polyols which can be used is that of the so-called filled polyols (polymer polyols). These contain dispersed solid organic fillers up to a solids content of 40 wt % or more. The following are among those which may be used:

SAN polyols: These are highly reactive polyols containing a dispersed copolymer based on styrene-acrylonitrile (SAN).
PHD polyols: These are highly reactive polyols containing polyurea, likewise in dispersed form.
PIPA polyols: These are highly reactive polyols containing a dispersed polyurethane, for example formed by in situ reaction of an isocyanate with an alkanolamine in a conventional polyol.

The solids content, which is preferably between 5 and 40 wt %, based on the polyol, depending on the application, is responsible for improved cell opening, and so the polyol can be foamed in a controlled fashion, in particular with TDI, and no shrinkage of the foams occurs. The solid thus acts as an essential processing aid. A further function is to control the hardness via the solids content, since higher solids contents bring about a higher hardness on the part of the foam.

The formulations with solids-containing polyols are distinctly less self-stable and therefore tend to require physical stabilization in addition to the chemical stabilization due to the crosslinking reaction.

Depending on the solids contents of the polyols, these are used either alone or in a blend with the abovementioned unfilled polyols.

An isocyanate component:polyol component ratio which is preferred for the purposes of this invention is expressed as the index and is in the range from 10 to 1000, preferably from 40 to 350. This index describes the ratio of isocyanate actually used to the isocyanate computed for a stoichiometric reaction with polyol. An index of 100 represents a molar ratio of 1:1 for the reactive groups.

Suitable catalysts for possible use in the process of the present invention are preferably substances to catalyse the gel reaction (isocyanate-polyol), the blowing reaction (isocyanate-water) or the di- or trimerization of the isocyanate. Typical examples are amines, e.g. triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethylaminoethoxyethanol and bis(dimethylaminoethyl) ether, tin salts of organic carboxylic acids, tin compounds such as dibutyltin dilaurate and potassium salts such as potassium acetate. It is preferable for further catalysts used to contain no organotin compounds, especially no dibutyltin dilaurate.

The amounts in which these catalysts are suitably used in the process of the present invention depend on the type of catalyst and typically range from 0.01 to 5 pphp (=parts by weight based on 100 parts by weight of polyol) or from 0.1 to 10 pphp in the case of potassium salts.

The amount of water suitably present in the process of the present invention depends on whether or not physical blowing agents are used in addition to water. In the case of purely water-blown foams, the water contents typically range from 1 to 20 pphp; when other blowing agents are used in addition, the amount of water used typically decreases to 0 or to the range from 0.1 to 5 pphp. To achieve high foam densities, neither water nor any other blowing agent is used.

Suitable physical blowing agents for the purposes of this invention are gases, for example liquefied CO2, and volatile liquids, for example hydrocarbons of 4 or 5 carbon atoms, preferably cyclo-, iso- and n-pentane, hydrofluorocarbons, preferably HFC 245fa, HFC 134a and HFC 365mfc, hydrochlorofluorocarbons, preferably HCFC 141b, oxygen-containing compounds such as methyl formate and dimethoxymethane, or hydrochlorocarbons, preferably dichloromethane and 1,2-dichloroethane. Suitable blowing agents further include ketones (e.g. acetone) or aldehydes (e.g. methylal).

Stabilizers used may be the substances mentioned in the prior art. The compositions of the present invention may advantageously contain one or more stabilizers. They are in particular silicon compounds comprising carbon atoms and preferably selected from polysiloxanes, polydimethylsiloxanes, organomodified polysiloxanes, polyether-modified polysiloxanes and polyether-polysiloxane copolymers.

Useful silicon compounds comprising one or more carbon atoms include the substances mentioned in the prior art. Preference is given to using such silicon compounds as are particularly suitable for the particular type of foam. Suitable siloxanes are described for example in the following references: EP 0839852, EP 1544235, DE 10 2004 001 408, WO 2005/118668, US 20070072951, DE 2533074, EP 1537159, EP 533202, U.S. Pat. No. 3,933,695, EP 0780414, DE 4239054, DE 4229402, EP 867465. The silicon compounds may be obtained as described in the prior art. Suitable examples are described for instance in U.S. Pat. No. 4,147,847, EP 0493836 and U.S. Pat. No. 4,855,379.

Organomodified silicon compounds can be used in particular. Useful organomodified silicon compounds which are particularly preferred include, for example, those conforming to the following formula (IV):

Mk Dm D′n To Qp (IV)

where

### M=[R2R12SiO1/2]

### D=[R1R1SiO2/2]

### D′=[R3R1SiO2/2]

### T=[R1SiO3/2]

### Q=[SiO4/2],

k=0 to 22, preferably 2 to 10, more preferably 2,
m=0 to 400, preferably 0 to 200, more preferably 2 to 100,
n=0 to 50, preferably 0.5 to 20, more preferably 0.7 to 9,
o=0 to 10, preferably 0 to 5, especially 0
p=0 to 10, preferably 0 to 5, especially 0

### R2=R1 or R3

R1=independently alkyl moiety, aryl moiety or H, preferably methyl, ethyl, propyl or phenyl, preferably methyl or phenyl
R3=organic modifications e.g. polyethers or a monovalent moiety of 1 to 30 carbon atoms with at least one heteroatom selected from the group N, S, O, P, F, Cl, Br
The R3 in formula (IV) are preferably moieties from the group

### —CH2CH2CH2O[CH2CH2O]a[CH2CH(CH3)O]b[CHR4CHR4O]cR5

### —CH2CH2CH2CN

### —CH2CH2CF3

### —CH2CH2CH2Cl

where
R5=alkyl, aryl, urethane, carboxyl, silyl or H, preferably H, Me, or —C(O)Me
R4=alkyl, aryl, which may each be optionally interrupted by oxygen, more preferably H, Me, Et or Ph,
a=0 to 100, preferably 0.5 to 70, more preferably 1 to 40,
b=0 to 100, preferably 0.5 to 70, more preferably 0 to 40,
c=0 to 50, preferably 0 to 15, especially 0
a+b+c>3.

Unmodified silicon compounds can be used in particular.

Useful unmodified silicon compounds which are particularly preferred include, for example, those conforming to the following formula (V):

Mq Dr (V)

where
M and D as defined for above formula (IV), and
q=2
r=0 to 50, preferably 1 to 40, more preferably 2 to 30.

The abovementioned silicon compounds, especially of formula (IV) and/or (V), may with particular preference be used individually or combined with one another. A compatibilizer may additionally be used in the case of mixtures. This compatibilizer may be selected from the group of aliphatic or aromatic hydrocarbons, more preferably aliphatic polyethers or polyesters.

It may be advantageous for at least 10% by equivalence (and at most 50% by equivalence) of the R2 moieties in the siloxane compounds of formula (IV) to be alkyl groups of 8 to 22 carbon atoms (based on the overall number of R2 moieties in the siloxane compound).

From 0.05 to 10 parts by mass of silicon compounds may preferably be used per 100 parts by mass of polyol components.

It is especially when the aforementioned silicon compounds are used in combination with the pentaethylenehexamine to be used according to the present invention that very good results are made possible with regard to the polyurethanes sought according to the present invention.

In addition to or in lieu of water and any physical blowing agents, the additive composition of the present invention may also include other chemical blowing agents that react with isocyanates by evolving a gas, examples being formic acid and carbonates.

Suitable and optional flame retardants for the purposes of this invention are preferably liquid organophosphorus compounds, such as halogen-free organic phosphates, e.g. triethyl phosphate (TEP), halogenated phosphates, e.g. tris(1-chloro-2-propyl) phosphate (TCPP) and tris(2-chloroethyl) phosphate (TCEP), and organic phosphonates, e.g. dimethyl methanephosphonate (DMMP), dimethyl propanephosphonate (DMPP), or solids such as ammonium polyphosphate (APP) and red phosphorus. Suitable flame retardants further include halogenated compounds, for example halogenated polyols, and also solids such as melamine and expandable graphite.

The process of the present invention provides polyurethane systems, in particular polyurethane foams, that are particularly low-emission with regard to aldehyde.

The term polyurethane within the meaning of the present invention is to be understood in particular as a generic term for any polymer obtained from di- or polyisocyanates and polyols or other isocyanate-reactive species, such as amines for example, in that the urethane bond need not be the only or predominant type of bond. Polyisocyanurates and polyureas are also expressly included.

The production of polyurethane systems in the manner of the present invention, in particular polyurethane foams, and/or the production of polyurethane systems/polyurethane foams may be effected by any process known to a person skilled in the art, for example by hand mixing or preferably using high-pressure or low-pressure foaming machines. The process of the present invention can be carried out as a continuous operation or as a batch operation. Batch operation is preferable for the process to produce molded foams, refrigerators or panels. A continuous process is preferable to produce insulation panels, metal composite elements, slabs or for spraying techniques.

In the process of the present invention, the pentaethylenehexamine is preferably admixed directly before or, alternatively, during the reaction to form the urethane bonds. The compound is preferably admixed in a mixing head, and also in a batch process for ready-produced polyol systems.

The term pentaethylenehexamine shall for the purposes of this invention also comprehend branched and cyclic isomers of pentaethylenehexamine. Pentaethylenehexamine in its commercially available, technical-grade quality is usable for the purposes of the present invention and leads to the advantages found by us. Linear pentaethylenehexamine may be used in particular.

The invention further provides a polyurethane system, in particular a polyurethane foam, obtained by a process as described above.

The polyurethane systems obtainable according to the present invention may preferably include 0.001 to 10 wt %, advantageously 0.01 to 5 wt %, especially 0.1 to 3 wt % of pentaethylenehexamine, based on the overall composition of the polyurethane system.

The polyurethane systems of the present invention may preferably be, for example, a rigid polyurethane foam, a flexible polyurethane foam, a viscoelastic foam, an HR foam, a semi-rigid polyurethane foam, a thermoformable polyurethane foam or an integral foam, preferably an HR polyurethane foam.

The polyurethane systems, preferably polyurethane foams, of the present invention can be used for example as refrigerator insulation, insulation panel, sandwich element, pipe insulation, spray foam, 1- and 1.5-component can foam (a 1.5-component can foam is a foam that is produced by destroying a container in the can), wood imitation, modelling foam, packaging foam, mattress, furniture cushioning, automotive seat cushioning, headrest, dashboard, automotive interior, automotive roof liner, sound absorption material, steering wheel, shoe sole, carpet backing foam, filter foam, sealing foam, sealant and adhesive or for producing corresponding products.

The invention further provides a polyurethane foam production composition comprising at least one urethane and/or isocyanurate catalyst, at least one blowing agent, at least one isocyanate component and at least one polyol component, while pentaethylene hexamine is present as additive. The notion of composition in this sense also comprehends multicomponent compositions wherein two or more components have to be mixed to produce a chemical reaction leading to polyurethane foam production. The notion of composition comprehends in particular the mix (mixture) of at least one urethane and/or isocyanurate catalyst, at least one blowing agent, at least one isocyanate component and at least one polyol component and also a pentaethylenehexamine.

A preferred polyurethane foam production composition according to the present invention may contain polyol, for example in amounts of 25 to 75 wt %, water, for example in amounts of 1 to 7 wt %, catalyst, for example in amounts of 0.05 to 3 wt %, physical blowing agent, for example in amounts of 0 to 25 wt % (e.g. 0.1 to 25 wt %), stabilizers (such as, for example, silicon-containing and non-silicon-containing, in particular silicon-containing and non-silicon-containing organic stabilizers and surfactants), for example in amounts of 0.3 to 5 wt %, isocyanate, for example in amounts of 20 to 50 wt %, and the pentaethylenehexamine to be used according to the present invention, for example in amounts of 0.00001 to 5 wt % (preferably 0.00005 to 2.5 wt %).

As regards preferred embodiments of these aforementioned compositions, the preceding description is referenced particularly with respect to the pentaethylenehexamine to be used.

The invention further provides a process for reducing aldehyde total emission, in particular aldehyde emissions comprising formaldehyde, acetaldehyde, propionaldehyde, acrolein, and also aromatic aldehydes, such as benzaldehyde, advantageously aldehyde emissions comprising formaldehyde, propionaldehyde, acetaldehyde, acrolein and benzaldehyde, in particular aldehyde emissions comprising formaldehyde, propionaldehyde and acetaldehyde, from polyurethane systems (in particular polyurethane foams) by admixture to the polyurethane system (in particular the polyurethane foam) of pentaethylenehexamine as recited above, preferably in an amount of 0.0001 to 10 wt %, advantageously 0.01 to 5 wt %, especially 0.1 to 3 wt %, based on the overall weight of the polyurethane system (in particular of the polyurethane foam), wherein the admixture may take place before, during or after the production of the polyurethane system, (in particular of the polyurethane foam).

The present invention further provides a polyurethane system (in particular a polyurethane foam) containing pentaethylenehexamine, as described above, in an amount of preferably 0.0001 to 10 wt %, advantageously 0.01 to 5 wt %, especially 0.1 to 3 wt % based on the overall weight of the polyurethane system (in particular of the polyurethane foam), obtainable in particular by admixing the pentaethylenehexamine before, during or after the production of the polyurethane system, in particular before or after the production of the polyurethane foam.

The invention further provides for the use of pentaethylenehexamine as described above for production of polyurethane foams that are low-emission with regard to aldehydes, preferably including formaldehyde, acetaldehyde, acrolein, propionaldehyde and benzaldehyde emissions, in particular low-emission with regard to formaldehyde, propionaldehyde and acetaldehyde.

The examples listed below illustrate the present invention by way of example, without any intention of restricting the invention, the scope of application of which is apparent from the entirety of the description and the claims, to the embodiments specified in the examples.

### EXAMPLES

TABLE 1
Raw materials for producing the foam moldings

| | |
|---|---|
| polyol 1 | trifunctional polyetherol, MW 6000, Bayer Material |
| | Science AG |
| polyol 2 | trifunctional polyetherol, MW 4500, Dow Chemicals |
| crosslinker | Tegoamine DEOA 85 (diethanolamine 85% in water), |
| | Evonik Industries AG |
| Catalyst | Tegoamine ZE1 (1,1′-[3-(dimethylamino) |
| | propyl]iminobispropan-2-ol), Evonik Industries AG |
| silicone stabilizer | Tegostab B 8734 LF 2, Evonik Industries AG |
| isocyanate | methylene diisocyanate, Suprasec 6506, NCO = 29.3%, |
| | Huntsman |

TABLE 2
Additives used

| additive | Description |
|---|---|
| additive 1 | Lupasol PR 8515 (polyethyleneimine), BASF |
| | Ludwigshafen |
| additive 2 | Pentaethylenehexamine (technical-grade |
| | quality), Aldrich |
| additive 3 | Acetaldehyde |
| additive 4 | Benzaldehyde |

### Example 1

### Production of Polyurethane Foams

The foams were produced by hand mixing. Polyol, crosslinker, catalyst, additive, water and silicone stabilizer were weighed into a beaker and premixed with a wing stirrer at 1000 rpm for 60 s. The isocyanate was then added and mixed in at a stirrer speed of 2500 rpm for 7 s. The reaction mixture was filled into a temperature-controlled box mold (dimensions 40×40×10 cm) at 57° C. and the box was sealed. The ready-produced foam was demolded after 3.5 minutes. The materials and quantities used are shown in Table 3.

Molded foams produced by the method described above were then analyzed for their formaldehyde, acetaldehyde and propionaldehyde content in line with VDA 275 (VDA 275 “Mouldings for the Automotive Interior—Determination of Formaldehyde Release.” Measurement by the modified bottle method; source: VDA 275, 07/1994, www.vda.de). The benzaldehyde content was determined using VDA 278 as of October 2011 (publisher/editor: VERBAND DER AUTOMOBILINDUSTRIE E. V. (VDA); Behrenstr. 35; 10117 Berlin; www.vda.de).

### VDA 275

### Principle of Measurement

In the method test specimens having a certain mass and size were secured above distilled water in a closed 1 L glass bottle and stored for a defined period at constant temperature. The bottles were subsequently cooled down and the absorbed formaldehyde was determined in the distilled water. The amount of formaldehyde determined was divided by the dry weight of the molding (mg/kg).

### Analysis

### Test Specimen: Sample Preparation, Sample Taking and Sample Dimensions

After demolding, the foams were stored at 21° C. and about 50% relative humidity for 24 hours. Samples were then taken at suitable and representative spots distributed uniformly across the width of the (cooled) molding. The foams were then wrapped in aluminum foil and sealed in a polyethylene bag.

The samples were each 100×40×40 mm thickness in size (about 9 g). Per molding, 3 samples were taken for the formaldehyde test.

### Test Procedure: Aldehyde Release

The sealed samples were subjected to direct determination immediately upon being received. The samples were weighed on an analytical balance to an accuracy of 0.001 g before analysis. A 50 ml quantity of distilled water was pipetted into each of the glass bottles used. The samples were introduced into the glass bottle, and the vessel was sealed and kept at a constant temperature of 60° C. in a thermal cabinet for 3 hours. The vessels were removed from the thermal cabinet after the test period. After standing at room temperature for 60 minutes, the samples were removed from the test bottle. This was followed by derivatization by the DNPH method (dinitrophenylhydrazine). For this, 900 μl of the aqueous phase were admixed with 100 μl of a DNPH solution. The DNPH solution was prepared as follows: 50 mg of DNPH in 40 mL of MeCN (acetonitrile) are acidulated with 250 μL of dilute HCl (1:10) and made up to 50 mL with MeCN. After the derivatization has been carried out, a sample is analyzed using HPLC. Separation into the individual aldehyde homologues is effected.

### HPLC Apparatus Parameters

The following apparatus was used for the analysis:

### Agilent Technologies 1260

Chromatography column: Phenomenex Luna 250*4.6 mm C18, 5μ particle size
Mobile phase: water acetonitrile gradient

### Detection: UV 365 nm

### VDA 278

### Principle of Measurement

The materials are characterized with regard to the type and the amount of the organic substances outgassable therefrom. To this end, two semi-quantitative empirical values are determined to estimate the emission of volatile organic compounds (VOC value) and also the proportion of condensable substances (fogging value). Individual substances of the emission are also determined. In the analysis, the samples are thermally extracted and the emissions are separated by gas chromatography and detected by mass spectrometry. The overall concentrations thus obtained for the VOC fraction are arithmetically converted into toluene equivalents and provide the VOC value as a result, the FOG fraction is represented in hexadecane equivalents and provides the FOG value.

The analytical method serves to determine emissions from non-metallic materials used for molded parts in motor vehicles, they also include foams.

In thermal desorption analysis (TDS), small amounts of material are heated up in a desorption tube in a defined manner and the volatile substances which are emitted in the course of heating are cryofocused by means of an inert gas stream in a cold trap of a temperature-programmable vaporizer. After the heating phase has ended, the cold trap is rapidly heated to 280° C. The focused substances vaporize in the process. They are subsequently separated in the gas-chromatographic separation column and detected by mass spectrometry. Calibration with reference substances permits a semi-quantitative estimate of the emission, expressed in “μg/g”. The quantitative reference substances used are toluene for the VOC analysis (VOC value) and n-hexadecane for the fogging value. Signal peaks can be assigned to substances using their mass spectra and retention indices. Source: VDA 278/10.2011, www.vda.de

The benzaldehyde amount determined was related to toluene equivalents (μg/g).

### Analysis

### Test Specimen: Sample Preparation, Sample Taking and Sample Dimensions

After demolding, the foams were stored at 21° C. and about 50% relative humidity for 24 hours. Samples were then taken at suitable and representative spots distributed uniformly across the width of the (cooled) molding. The foams were then wrapped in aluminum foil and sealed in a polyethylene bag.

The amount of the foam samples introduced into the desorption tubes was 10-15 mg in each case.

### Test Procedure: VOC/FOG Thermal Desorption

The sealed samples were subjected to direct determination immediately upon being received. The samples were weighed out on an analytical balance to an accuracy of 0.1 mg before starting the analysis and the corresponding amount of foam was placed centrally in the desorption tube. A helium stream was passed over the sample while the latter was heated to 90° C. for 30 minutes. All the volatile substances were collected in a cold trap cooled with liquid nitrogen. The cold trap was heated up to 280° C. after 30 minutes. The vaporizing substances were separated from each other using the gas-chromatographic column described and then analyzed by mass spectroscopy.

### GC-MS Instrument Parameters.

The following apparatus was used for the analysis:

### Gerstel

### D-45473 Mühlheim an der Ruhr,

### Eberhard-Gerstel-Platz 1 TDS-3/KAS-4

Tenax® desorption tube

### Agilent Technologies 7890A (GC)/5975C (MS)

### Column: HP Ultra2 (50 m, 0.32 mm, 0.52 μm)

Carrier gas: helium

TABLE 3
Formulation for producing the moldings and results of formaldehyde, acetaldehyde,
propionaldehyde and benzaldehyde measurements

| Examples | V1 | V2 | EM1 | V3 | EM2 | V4 | EM3 |
|---|---|---|---|---|---|---|---|
| polyol 1 | 100 | 100 | 100 | 100 | 100 | 100 | 100 |
| polyol 2 | 3.5 | 3.5 | 3.5 | 3.5 | 3.5 | 3.5 | 3.5 |
| water | 3.1 | 3.1 | 3.1 | 3.1 | 3.1 | 3.1 | 3.1 |
| crosslinker | 0.6 | 0.6 | 0.6 | 0.6 | 0.6 | 0.6 | 0.6 |
| catalyst | 1.1 | 1.1 | 1.1 | 1.1 | 1.1 | 1.1 | 1.1 |
| silicone stabilizer | 0.7 | 0.7 | 0.7 | 0.7 | 0.7 | 0.7 | 0.7 |
| isocyanate index 83 | 44.36 | 44.36 | 44.36 | 44.36 | 44.36 | 44.36 | 44.36 |
| no additive | x | | | | | | |
| additive 1 | | 1.0 | | | | | |
| additive 2 | | | 1.0 | | 1.0 | | 0.5 |
| additive 3 | | | | 0.01 | 0.01 | | |
| additive 4 | | | | | | 0.005 | 0.005 |
| formaldehyde | 1.43 | 0.00 | 0.00 | 1.45 | 0.03 | | |
| emissions ppm (VDA | | | | | | | |
| 275, mod.) | | | | | | | |
| blank value of | 0.02 | 0.02 | 0.02 | 0.02 | 0.02 | | |
| formaldehyde/ppm | | | | | | | |
| acetaldehyde | 0.11 | 5.78 | 0.08 | 4.96 | 3.01 | | |
| emissions ppm (VDA | | | | | | | |
| 275, mod.) | | | | | | | |
| blank value of | 0.02 | 0.02 | 0.02 | 0.02 | 0.02 | | |
| acetaldehyde/ppm | | | | | | | |
| propionaldehyde | 0.64 | 0.84 | 0.51 | | | | |
| emissions ppm (VDA | | | | | | | |
| 275, mod.) | | | | | | | |
| blank value of | 0.01 | 0.01 | 0.01 | | | | |
| propionaldehyde/ppm | | | | | | | |
| benzaldehyde | | | | | | 20 | <1 |
| emissions VOC ppm | | | | | | | |
| (VDA 278) | | | | | | | |

The foaming results show that the addition of additive 1 (V2) does result in a significant decrease in the level of formaldehyde emissions, but the level of acetaldehyde emission is more than 50 times higher than for the comparative foam without additive (V1). Attention may likewise be additionally drawn to an increased propionaldehyde content. Admixing additive 2, by contrast, produces a positive effect in the form of reduced formaldehyde emissions, which are at the limit of detection, and also a likewise reduced acetaldehyde content (EM1) and there is also a positive effect on propionaldehyde emissions. Owing to the low levels of acetaldehyde even in the standard foam without additive (V1), a small amount of acetaldehyde (additive 3) was intentionally admixed to the foam as an impurification before foaming in order to increase the acetaldehyde levels and thereby increase the significance of the result (V3). It is again found that the admixture of additive 2 results in a quite appreciable lowering of the acetaldehyde content (EM2). A significant reduction in the propionaldehyde content was likewise observed. Comparative Example V4 shows the benzaldehyde emissions measured by VDA 278 in VOC section on admixture of additive 4. This value can be lowered down to the detection limit by admixing inventive additive 2.

The foaming results show that admixing the additive of the present invention, i.e. pentaethylenehexamine, PU foams are obtainable with reduced emissions of formaldehyde, acetaldehyde, propionaldehyde and also benzaldehyde.

1. A process for production of polyurethane systems by reacting at least one polyol component with at least one isocyanate component in the presence of one or more catalysts for the isocyanate-polyol and/or isocyanate-water reactions and/or the trimerization of isocyanate, characterized in that said reacting is carried out in the presence of pentaethylenehexamine.

2. The process according to claim 1, wherein pentaethylenehexamine is used in a mass fraction of 0.0001 to 10 parts, based on 100 parts of polyol component.

3. The process according to claim 1, wherein the polyurethane system produced is a polyurethane foam.

4. A polyurethane system obtainable by a process according to claim 1.

5. The polyurethane system according to claim 4, wherein it includes from 0.001 to 10 wt % of pentaethylenehexamine.

6. The polyurethane system according to claim 4, wherein the polyurethane system is a rigid polyurethane foam, a flexible polyurethane foam, a viscoelastic foam, an HR foam, a semi-rigid polyurethane foam, a thermoformable polyurethane foam or an integral foam, preferably an HR polyurethane foam.

7-9. (canceled)

10. A polyurethane system (in particular a polyurethane foam) containing pentaethylenehexamine in an amount of 0.0001 to 10 wt % based on the overall weight of the polyurethane system (in particular of the polyurethane foam), obtainable in particular by admixing the pentaethylenehexamine before, during or after the production of the polyurethane system, in particular of the polyurethane foam.
